(19) United States
(12) Patent Application Publication
(10) Pub. No.: US 2018/0028281 A1
(43) Pub. Date: Feb. 1, 2018

(54) COMPLEX ORTHODONTIC SYSTEM AND METHOD FOR MANUFACTURING THE SAME

(71) Applicant: Shanghai EA Medical Instrument Company Limited, Shanghai (CN)

(72) Inventors: Huamin LI, Shanghai (CN); Ning DOU, Shanghai (CN)

(21) Appl. No.: 15/222,962

(22) Filed: Jul. 29, 2016

(51) Int. Cl. A61C 7/00; A61C 7/08

(52) U.S. Cl. CPC A61C 7/002; A61C 7/08

(57) ABSTRACT

A complex orthodontic system comprises: multiple sets of dental appliances, and the dental appliances have cavities of respective predetermined geometric shapes to move teeth of a patient from an initial tooth arrangement to an expected tooth arrangement gradually, wherein at least one set of the multiple sets of dental appliances comprises two or more dental appliances of substantially the same geometric shape. The resilience force of the dental appliance can be maintained during the use period by using the complex orthodontic system, which can also shorten the treatment cycle, save materials, and improve the treatment results and the use comfort.

### FIELD OF THE APPLICATION

The present disclosure is related to a complex orthodontic system and manufacturing method thereof, particularly to a complex invisible orthodontic system and manufacturing method thereof.

### BACKGROUND

There has developed various types of dental appliance for repositioning teeth of a patient. Compared with conventional treatments using braces, a new invisible orthodontic treatment does not require brackets and wires, instead it uses a series of invisible dental appliances (i.e. housing dental appliances) made of safe elastic transparent polymer materials. Therefore, the invisible orthodontic treatment is almost unnoticeable, and may not affect daily life or social activity. The patients may take on or off the invisible appliances by themselves, therefore the dental hygiene can be maintained normally. The entire orthodontic treatment is easy to conduct with good time efficiency.

The aforementioned dental appliance is a set of polymer housings with internal cavities where teeth can fit in. The geometry of the cavities for teeth is compatible with the arrangement/position of teeth after repositioning so that the teeth can be rearranged after using a set of dental appliances. Generally, it would take at least 4 successive steps to reposition teeth from an initial state to a final state, and sometimes it would take at least 20 steps. For complex cases, it might even require 40 or more steps. For each dental appliance, the patient needs to wear it for a period of time to allow for the rearrangement of teeth under the force applied by the elastic housing dental appliance.

In a conventional method for manufacturing conventional invisible dental appliances, as illustrated in FIG. 1, firstly the patient's teeth will be scanned to collect information about the initial teeth arrangement. Based on the initial teeth arrangement, digital data of a set of the final teeth arrangement can be generated by virtual orthodontic treatment designs. A set of tooth models representing the final teeth arrangement are then manufactured using rapid prototyping technology or a numerical control machine. Each tooth model will be used as a male mold to manufacture the corresponding dental appliance. Generally speaking, for each orthodontic treatment step, the dental appliance will be used for 14 days.

However, in practical use, the teeth repositioning by wearing the invisible dental appliances may not have the same effect as designed initially. For example, after being used for a week, the elastic stress of the dental appliance gets weaker due to deformation. Moreover, the errors accumulated during the orthodontic treatment introduced by the limited processing accuracy would lead to a deviation from desired treatment effect and longer treatment cycles. Therefore, adjustment on the original design is required during the treatment, which even requires recollection of clinical data, getting tooth impression mold, redesigning orthodontic treatment plan and re-manufacturing tooth model to make a new dental appliance, resulting in a waste of time, manpower and materials.

### SUMMARY

The present application provides a complex orthodontic system and a method for manufacturing such orthodontic system, which requires no additional or even reduced use of male molds for manufacturing the dental appliances, while ensures the elastic stress of the dental appliance during the treatment, shortens the treatment cycle, saves materials and improves the treatment comfort level and treating results.

Correspondingly, according to one aspect, the present application provides a complex orthodontic system, comprising: multiple sets of dental appliances, which have cavities of respective predetermined geometric shapes to move teeth from an initial tooth arrangement to an expected tooth arrangement gradually. At least one of the multiple sets of dental appliances comprises two or more dental appliances of substantially the same geometric shape.

According to one embodiment of the present application, when the aforementioned two or more dental appliances are put on the teeth of the patient respectively, orthodontic forces applied to the teeth by the two or more dental appliances are different. Preferably, a first dental appliance with a smaller orthodontic force is put on the teeth of the patient for a first suggested period of time, and after the first suggested period of time, the dental appliance with the smaller orthodontic force is replaced by a second dental appliance with a larger orthodontic force, which is put on the teeth of the patient for a second suggested period of time.

According to one embodiment of the present application, the two or more dental appliances have different thicknesses. Preferably, a first dental appliance with a thinner thickness is put on the teeth of the patient for a first suggested period of time, and after the first suggested period of time, the first dental appliance is replaced by a second dental appliance with a thicker thickness, which is put on the teeth of the patient for a second suggested period of time.

According to one embodiment of the present application, the two or more dental appliances are made of materials with different elastic modulus. Preferably, a first dental appliance made of a first material with a smaller elastic modulus is put on the teeth of the patient for a first suggested period of time, and after the first suggested period of time, the first dental appliance made of the first material with the smaller elastic modulus is replaced by a second dental appliance made of a second material with a larger elastic modulus, which is put on the teeth of the patient for a second suggested period of time.

According to one embodiment of the present application, the two or more dental appliances are post-processed differently, so that orthodontic forces applied to the teeth of the patient by the two or more dental appliances are different, when the two or more dental appliances are put on the teeth of the patient, respectively.

According to one embodiment of the present application, the two or more dental appliances have different attachments, so that orthodontic forces applied to the teeth of the patient by the two or more dental appliances are different, when the two or more dental appliances are put on the teeth of the patient, respectively.

According to another aspect of the present application, a method for manufacturing complex dental appliances is provided, comprising the following steps: a) collecting a dental digital model representing an orthodontic status; b) making a male mold for dental appliance based on the dental digital model; and c) manufacturing two or more dental appliances based on the male mold for dental appliance, wherein the two or more dental appliances are of substantially the same geometric shape.

According to another aspect of the present application, a method for manufacturing complex dental appliances is provided, comprising the following steps: a) acquiring a dental digital model representing an orthodontic status; b) generating a digital model for dental appliance based on the dental digital model; and c) manufacturing two or more dental appliances of substantially the same geometric shape based on the same digital model for dental appliance.

According to another aspect of the present application, a method for using a complex orthodontic system is provided, comprising the following steps: applying a first dental appliance of a set of dental appliances to teeth of a patient for a first suggested period of time, wherein the set of dental appliances comprise two or more dental appliances having substantially the same geometric shape; and replacing the first dental appliance with a second dental appliance of the set of dental appliances for a second suggested period of time after the first suggested period of time.

Based on the aforementioned complex orthodontic systems, manufacturing method thereof, and use method thereof, the number of male molds for dental appliance required for manufacturing dental appliances can be reduced, and less manpower, materials, time cost are required. For each treatment step, the use time for each invisible dental appliance is reduced by using two or more invisible dental appliances for the treatment, which ensures the elasticity of the dental appliance during use, shortens the treatment cycle, and improves the treatment results.

Besides, to maximize the accuracy, comfort level, and treatment results of the dental appliance, two or more invisible dental appliances in a set are made of materials with different thicknesses or different kinds of materials, or two or more invisible dental appliances in a set are applied with different post-processing methods or attachments, in different processing order.

### BRIEF DESCRIPTION OF THE DRAWINGS

Above and other features of the present application will be further described below in combination with the drawings and their detailed illustration. It should be understood that the drawings merely illustrates some exemplary embodiments of the application and should not be regarded as limitations to the protection scope of the application. Unless otherwise stated, the drawings are not necessarily proportional and similar labels in the drawings represent similar components.

FIG. 1 illustrates a diagram of a method for manufacturing dental appliances according to an existing technology.

FIG. 2 illustrates a flow chart of a method for manufacturing dental appliances according to an embodiment of the present invention.

FIG. 3 illustrates a flowchart of a method for manufacturing dental appliances according to another embodiment of the present invention.

FIG. 4 illustrates a diagram of a complex orthodontic system according to an embodiment of the present invention.

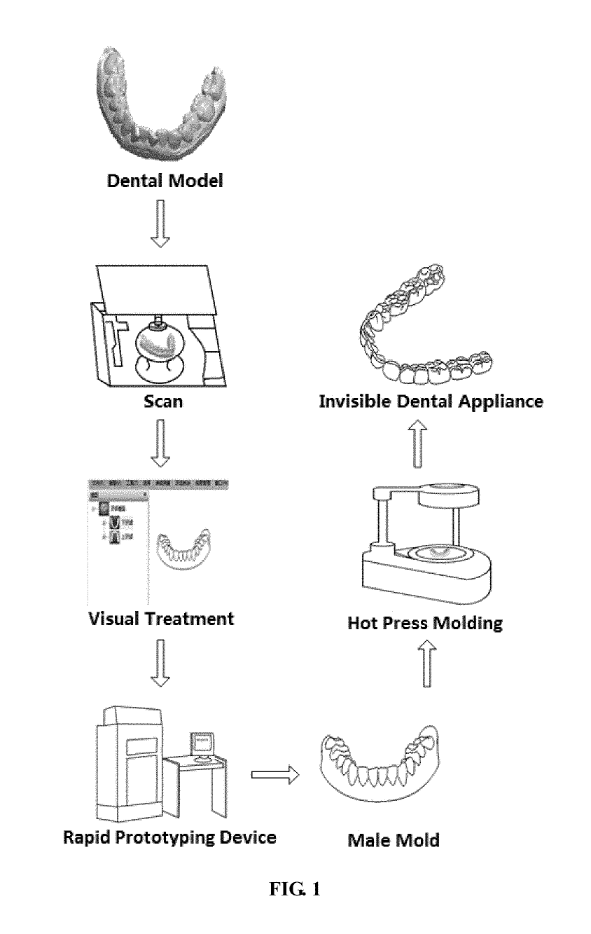

### DETAILED DESCRIPTION OF ILLUSTRATED EMBODIMENTS

The detailed description below referenced accompanying drawings that constitute part of the specification. The specification and accompanying drawings are merely used for illustration purpose and should not be considered as limitation to the scope of the present application. It is understood for a person skilled in the art that many other embodiments may be used and variations may be made on the embodiments described above without departing from the spirit and protection scope of the present application. It should be understood that, various aspects of the present disclosure described and illustrated herein may be arranged, replaced, combined, separated or designed by many different configurations, and all these configurations are included in the present application.

### A Method for Manufacturing Dental Appliances Using Male Molds

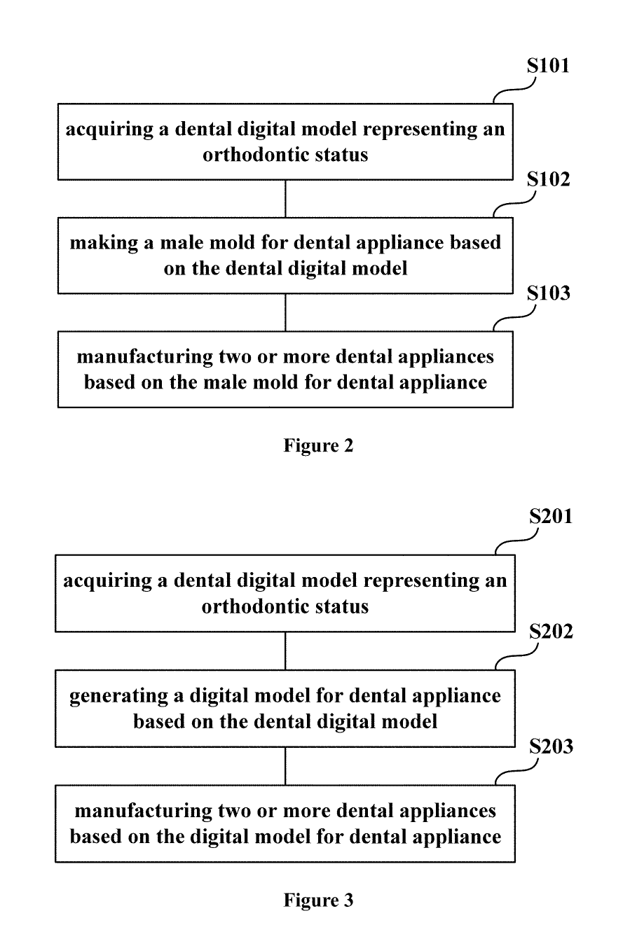

FIG. 2 illustrates a method for manufacturing dental appliances according to an embodiment of the present invention.

Firstly, at step S101, a dental digital model representing a dental orthodontic status is acquired, wherein the dental digital model representing the dental orthodontic status refers to a computer digital model used to instruct manufacturing of a tooth model. The resulting tooth model is a three-dimensional model of a dental state (or a tooth arrangement). The orthodontic status includes a series of dental states after receiving the treatment, and each dental state corresponds to a dental digital model. Each dental state includes geometric shapes of several teeth at one treatment step and the relative positions between these teeth. Therefore, each dental digital model includes a digital data set of the geometric shapes and relative positions of several teeth.

In an exemplary embodiment, a physical tooth model can be generated based on a current dental state, or the state of teeth and surrounding tissues (such as gums, facial soft tissue) of the patient. For example, a plaster tooth model can be made by means of impression. The physical tooth model is later scanned to generate a virtual tooth model representing the initial arrangement of the patient's teeth (corresponding to the initial dental orthodontic status). The images of teeth or surrounding tissues can also be acquired by optical scanning, three-dimensional photography, three-dimensional recording, or medical CT scanning. The images are processed by a computer to generate the initial virtual tooth model, which can be processed and displayed in a digital manner.

Next, based on the initial virtual tooth model and a treatment target for the patient, at least one treatment parameter can be chosen. The computer system generates a series of gradually progressive dental states automatically (i.e. desired dental states or tooth arrangements after receiving respective treatments), according to the initial virtual tooth model and the at least one treatment parameter. The series of dental states reflect the beneficial changes on the tooth structure or arrangement compared with the initial tooth model after performing a series of orthodontic steps. Generally, the entire treatment includes at least one orthodontic step (such as including 20-40 orthodontic steps), and each orthodontic step corresponds to an orthodontic status, which corresponds to a dental digital model. Therefore, the computer system can generate and store a set of dental digital models.

However, the present invention is not limited to the method of generating targeted orthodontic status gradually based on the initial tooth model and treatment goal, but may use uses other methods. For example, after generating the digital model of the initial dental state and the digital model of the desired dental state, the computer system can generate digital models representing a series of intermediate dental states based on the digital models of the initial and desired dental states. Such method provides an alternative way to achieve the digital model representing orthodontic status as described in the present invention.

Next, at step S102, a physical tooth model (i.e. a male mold for dental appliance) is made based on the dental digital model. In other words, corresponding physical tooth models are made based on a series of dental digital models.

Preferably, a male mold is made using rapid prototyping technology. The rapid prototyping technology can be classified into the following forming processes: Stereo lithography Apparatus (SLA), Laminated Object Manufacturing (LOM), Laser Sintering (SLS), Fused Deposition Modeling (FDM), Three Dimensional Printing (3DP) etc. The molding materials are mainly organic polymers, such as light-cured resin, nylon, waxes etc. During the SLA process, laser is used to solidify the light-cured resin point by point, inducing the chemical reaction on the material to make it solidified for molding. During the LOM process, the foil materials (paper, foil, ceramics, metal foils, etc.) are cut by laser, and the foil materials can be combined layer by layer, using hot melt adhesives because of the heat transfer and the pressure applied by heat roller. The SLS process uses laser to illuminate point by point until the powder materials or the solid adhesive covering the power melt to realize the molding process. During the FDM process, the thermoplastic molding materials is continuously fed into a nozzle, where the thermoplastic molding materials is heated, melt and then discharged to form a desired shape gradually. The 3DP injects molding molten material by means similar to the ink-jet printing method, or sprays adhesive to bond power materials point by point.

In an embodiment, the tooth model is made by the SLA method. In particular, to make a tooth model, on the basis of polymerization reaction of photosensitive resin, a laser controlled by a computer scans the liquid resin point by point along a sectional outline of each layer of the tooth model, so that the scanned thin resin layer will be polymerized from dots to lines, forming a cured cross-section of a thin layer of the tooth model, while the un-scanned resin remains in the initial liquid phase. When the curing of one layer is complete, a lift table moves by a distance of the thickness of one layer and covers the previous cured resin layer with another new liquid resin, which can be scanned and cured again. The newly cured layer sticks firmly to the previous layer, which can be repeated until the entire tooth model fabrication is complete. Typically, to ensure a smooth surface of the resin, the photosensitive resin is swept by a mechanical knife. After the tooth model is finished, the lift table moves up and the tooth model is removed from the device. Typically, the initial tooth model will be washed in solvent such as Acetone, which only dissolves the uncured liquid resin and does not dissolve the cured solid medium. Subsequently, the model is placed under a high intensity UV light to complete the curing process and to obtain the tooth model, i.e. the positive or male mold for manufacturing the dental appliances.

Note that, even though the present invention describes the rapid prototyping technology using the SLA method as an example, the present invention is not limited to the SLA method and the tooth model can be manufactured by any other rapid prototyping methods.

After the tooth model is made by a rapid prototyping method, at step S103, dental appliances are manufactured based on the tooth model, i.e. the male mold for dental appliance.

According to one embodiment, using a positive pressure lamination technique, a membrane of dental appliance formed by transparent polymer material(s) (elastic polymer, such as polycarbonate) is pressed on the aforementioned tooth model using a hot press molding device to form a housing, so as to obtain a dental appliance. However, the method for manufacturing dental appliances based on tooth models is not limited to hot press molding, other methods can also be used to manufacture dental appliances based on tooth models.

As to existing technologies, a tooth model (i.e. a male mold for dental appliance) can only be used for manufacturing one dental appliance. In other words, only one tooth model is generated for each orthodontic step, and only one dental appliance can be manufactured based on the tooth model.

However, according to the present invention, step S103 includes two or more sub-steps for manufacturing dental appliances. Taking step S103 with two sub-steps for manufacturing dental appliances as an example, the present invention will be illustrated with more details in the following paragraphs.

In an example, step S103 includes sub-steps S1031 and S1032 (not shown), wherein step S1031 includes manufacturing a first dental appliance using a first polymer membrane, based on the tooth model.

Next, at step S1032, a second dental appliance is manufactured using a second polymer membrane, based on the same tooth model. The second polymer membrane can be of a different type or of the same type as the first polymer membrane, which will be illustrated in details as below.

Since both the first dental appliance and the second dental appliance are manufactured based on the same tooth model or male mold, the geometric shapes of cavities of these two dental appliances are substantially the same. However, an orthodontic force applied to the patient's teeth by a dental appliance is not only related to the geometric shape of the cavity of the dental appliance, but also related to other factors. For example, by choosing different thicknesses or materials for the first polymer membrane and the second polymer membrane, or performing different post-processing methods, or designing and attaching different attachments, the orthodontic forces of the first dental appliance and the second dental appliance may be different. When the patient wears the two dental appliances, the orthodontic forces applied to the teeth by these dental appliances are different. The effect of thickness, material, post-processing method and attachment on elastic coefficient and orthodontic force is listed as below.

Note that, although step S103 with two sub-steps, which allows for manufacturing two dental appliances by press molding based on one male mold, is taken as an example for illustration purpose, the present invention is not limited to such method. According to the present invention, step S103 can include more than two sub-steps, which allows for manufacturing more than two dental appliances by press molding, based on one male mold. The paragraphs below illustrate using manufacturing two dental appliances based on one male mold as an example, the spirit, technical solution and technical features can also be applied to manufacturing more than two (e.g. three or four) dental appliances, which will not be repeated herein.

A. Two or More Different Dental Appliances Manufactured Using Membranes with Different Thicknesses

Firstly, membranes with different thicknesses have different elastic coefficients and stress. For example, mechanical experiments were conducted on Biolon membranes (made in Germany) with thicknesses of 1.0 mm, 0.75 mm and 0.5 mm respectively. The membrane with the thickness of 1.00 mm has the largest elastic modulus and maximum stress, while the membrane with the thickness of 0.5 mm has the smallest elastic modulus and maximum stress. Therefore, the mechanical performance varies as the thickness of the material varies. The thicker the material is, the larger the elastic modulus and maximum stress is. The thinner the material is, the smaller the elastic modulus and maximum stress is. Therefore, the same membrane with different thicknesses possess different mechanical performances, and the mechanical performances of thermal lamination materials are proportional to the material thickness. The maximum stress is proportional to the elastic modulus, i.e. the larger the stress is, the larger the modulus is, and the ability to resist to elastic deformation is stronger. The greater the stiffness is, the smaller the elasticity is. The membranes of other brands or materials possess the same or similar characteristics and will not be repeated herein.

Therefore, in a specific embodiment, to achieve the expected treatment effect, a set of dental appliances consisting of several dental appliances, which will be used successively during the treatment, are manufactured with materials with proper thicknesses. The thinner the membrane is, the better the elasticity it has, which allows for more comfort for the patient during use. However when a smaller stress (orthodontic force) is applied, the rate and amount of teeth movement is smaller. Therefore the dental appliance made of a thinner membrane is more suitable as a dental appliance that is used first. With a thicker membrane, the elasticity of the dental appliance is worse, but the orthodontic force it applies to the teeth is stronger, allowing the rate and amount of teeth movement greater. Therefore, the dental appliance made of a thicker membrane is more suitable as the one used later during the treatment, providing a larger orthodontic force.

Moreover, during the process of pressing two dental appliances based on the same male mold, the dental appliance that is used later will be pressed first, and the dental appliance that is used first will be pressed later. That is because undesired deformation may be introduced to the resin material forming the male mold during the press process, making the dental appliance pressed first have higher precision. Therefore, the shape of the dental appliance pressed first would more conform to the desired state of the teeth at the treatment step. It is better to use such dental appliance later during the treatment, ensuring that the teeth can reach the desired state at the treatment step as designed by the computer.

In other words, at step S1031, a first dental appliance is manufactured using a first polymer membrane with a greater thickness based on one tooth model; and at step S1032, a second dental appliance is manufactured using a second polymer membrane with a smaller thickness based on the same tooth model. The patient wears the thinner second dental appliance for 6-7 days, and then switches to the thicker first dental appliance for 6-7 days, to complete one treatment cycle.

According to one embodiment of the present invention, for example, at step S1031, a first dental appliance is manufactured using a first polymer membrane with a thickness of 1.0 mm, based on a tooth model; at step S1032, a second dental appliance is manufactured using a second polymer membrane with a thickness of 0.75 mm, based on the same tooth model. The patient wears the second dental appliance with the thickness of 0.75 mm for 6-7 days, and then switches to the first dental appliance with the thickness of 0.75 mm for 6-7 days, to complete the treatment cycle. As the number of dental appliances for one treatment step changes from one to two, the situation that the orthodontic force would decrease due to deformation thereof is less likely to happen. Thus, for one treatment step, the time required for wearing dental appliances can be reduced (for example, from 14 days to 12 days).

More than two dental appliances can also be pressed based on one tooth model. According to one embodiment of the present invention, step S103 includes three sub-steps of manufacturing dental appliances. For example, at step S1031, the first dental appliance is manufactured using the first polymer membrane with a thickness of 1.0 mm, based on a tooth model; secondly, at step S1032, the second dental appliance is manufactured using the second membrane with a thickness of 0.75 mm, based on the same tooth model; lastly, at step S1033, a third dental appliance is manufactured using a third polymer membrane with a thickness of 0.5 mm, based on the same tooth model. The patient may wear the third dental appliance with the thickness of 0.5 mm for 4 days followed by wearing the second dental appliance with the thickness of 0.75 mm for 4 days, and then switches to the first dental appliance with the thickness of 1.0 mm for 4 days, to complete one treatment cycle.

B. Manufacturing Two or More Dental Appliances Using Membranes of Different Materials.

Technically, all biocompatible thermoplastic materials can be used to manufacture invisible dental appliances. For example, polycarbonate (PC) is a colorless transparent amorphous thermoplastic material. PC is a colorless transparent material with good heat resistance and good impact resistance, which can be used as fire retardant, and also has good mechanical properties at any temperature for ordinary use. Moreover, with good machinability, PC is a commonly used material for manufacturing invisible dental appliances.

There is always a possibility to use novel materials for manufacturing dental appliances. For example, both polyether ether ketone (PEEK) and polyether ketone ketone (PEKK) belong to polyaryletherketone (PAEK) family, which is a series of relatively new polymers with good heat resistance, no toxicity, and good thermoplasticity, including ether or ketone functional groups. For examples, PEEK resin can withstand up to 3000 autoclaving cycles at 134° C., which can be used to manufacture surgical or dental equipment having high requirement on sterilization, and required to be used repeatedly. PEEK is not only light-weighted, non-toxic and corrosion resistive, but also a material closest to human bones and combinable with human body. Therefore, replacing metal with PEEK resin for making human bones is one of the most important medical applications of PEEK. Besides, PEEK is suitable for extrusion and injection molding, implying a good machinability and high forming efficiency.

PEKK is a polymer with amain chain structure including repeated units consisting of two ketonic bonds and an ether linkage. As a special polymer, it also has superior properties as polyaryletherketone polymers. Moreover, polyoxymethylene (POM), also known as acetal resin, also has great application potential and has been introduced as a replacement for traditional polymethyl methacrylate. The relatively high proportion of the limits allows POM to have a large enough range of elasticity.

Therefore, at the filing of the application or in the future, many materials might be found suitable for manufacturing invisible dental appliances. The elastic modulus and deformation stress may be different for each kind of material. For example, three dental appliances are manufactured from PEEK, PEKK and POM with the same thickness, respectively, in order to study the influence of materials on orthodontic force. As a result, the dental appliance manufactured from PEEK has the highest elastic modulus, resulting in a largest orthodontic force, followed by PEKK and POM. Different materials have different properties, and thus the dental appliances manufactured from different materials would generate different orthodontic forces.

According to one embodiment, two or more dental appliances may be manufactured from different materials based on one tooth model, to achieve the ideal treatment effect. The smaller the elastic modulus of the material is, the better the elasticity it possesses. It is comfortable for the patient to wear the dental appliance made of a material with smaller elastic modulus at the beginning, and the rate and amount of teeth movement is smaller due to smaller deformation stress (orthodontic force). Therefore, the material with a smaller elastic modulus is suitable for making the dental appliance used at the beginning of the treatment. The greater the elastic modulus is, the less the elasticity is but the larger the stress it can provide, leading to a higher rate and more teeth movement. Therefore, the material with a greater elastic modulus is more suitable for making the dental appliance used later in the treatment cycle to provide a larger orthodontic force.

Moreover, as mentioned in section A of the present application, in the process of manufacturing two dental appliances based on one male mold, the dental appliance that may be used later is manufactured first, and the dental appliance that may be used first is manufactured later, to ensure the manufacturing precision.

Note that, the material properties mentioned here not only refer to the original material properties due to their compositions or brands, but also the material properties that may be affected by pretreatment process. For example, after immersing a membrane of a specific brand with a specific thickness into artificial saliva for two weeks, its maximum stress and elastic modulus both increase, resulting in different material properties. Therefore, if such membrane is used for manufacturing dental appliances, the dental appliances manufactured using the materials immersed in the saliva will have a different material property compared with those manufactured using the membrane without immersion into the artificial saliva. The material properties affected by the pretreatment mentioned above also belong to the material properties covered by the present invention.

C. Introducing Post-Process to Manufacture Two or More Different Dental Appliances

The pre-process or post-process (collectively referred to as “post-process”) performed on membranes or invisible dental appliances will influence their elasticity. Therefore, after immersing the invisible dental appliances into artificial saliva for two weeks, the maximum stress and elastic modulus of the invisible dental appliances may both increase, which might be due to the fact that the material becomes thicker after the immersion into the artificial saliva, leading to improved mechanical properties.

According to another embodiment of the present invention, two identical dental appliances are pressed using membranes of the same material with the same thickness, and one of two dental appliances is immersed in artificial saliva or a similar solution for two weeks, in order to have an increased stress and elastic modulus. Since the membrane without receiving the post-process has better elasticity, it is more comfortable to wear for the patient, and the rate and amount of teeth movement are smaller because of the smaller stress applied, which makes the dental appliance manufactured from the membrane more suitable for use at the beginning of the treatment. As for the membrane processed using post-process methods, it has smaller elasticity but larger stress, which leads to a higher rate and larger amount of teeth movement, and thus is more suitable for a later use in the treatment to provide a larger orthodontic force.

Moreover, as mentioned in section A above, at step S103, in the process of pressing two dental appliances based on one male mold, the dental appliance that may be used later is pressed first and the dental appliance that may be used first will be pressed later, in order to achieve higher manufacturing precision. In addition, post-processing sub-steps that perform post-process on the later-used dental appliance are added to increase the elastic modulus.

Alternatively, the post-process (such as immersion into artificial saliva) can be performed onto both of the dental appliances, but the extent of post-process, such as the duration for immersion in artificial saliva or the concentration of the artificial saliva, is controlled to ensure that the elastic modulus of the later-used dental appliance is larger than that of the first-used dental appliance.

Therefore, performing different post-processes mentioned in the present invention not only includes performing a post-process on each of the two or more dental appliances in one set with different methods, but also includes performing post-processes on a portion of the two or more dental appliances while leaving the rest of the two or more dental appliances without receiving any post-process. Both the two cases fall within the scope of the present invention.

D. Introducing Attachments to Manufacture Two or More Dental Appliances.

The type and shape of attachments of invisible dental appliances can change the elasticity of the dental appliances as well. Many attachments can be introduced, including at least one of depressions, apertures, openings and/or projections.

For example, according to one embodiment, micro-projections on a thin inner-wall of the invisible dental appliances (also known as orthodontic side stem) can generate a lateral orthodontic force, adjust an orthodontic force distribution, and improve the anchorage condition. An orthodontic side stem is generally positioned at a position of the dental appliance corresponding to an interface between two teeth, or on a region near the side of molars where is uneven. The force applied by the side stem is realized by friction generated against the interface between the two teeth, the uneven part of the side of maxillary tooth of the side of molars (mainly the tooth), the inside of the side stem and the side of the tooth.

According to another embodiment, an orthodontic tracting hook can also be mounted on the outside of the thin wall of the dental appliance. The current tracting hook is normally attached to one or only few teeth, which is not in an ideal supporting form. The tracting hook in the present invention can be mounted on the thin wall of the dental appliance. The tracting hook and the dental appliance can be formed separately and then connected together, or integrated as a single piece. Besides the regular design of the tracting hook that can fulfill the tracting requirement, it also needs to consider an additional orthodontic force, which is a result of elastic deformation of dental appliance caused by a reaction force to the tracting force of tracting hook generated during use, and another additional tracting force which is a result of the impact of resilience force of dental appliance on the tracting device. In fact, the orthodontic and tracting functions are realized by the coupling of those forces. A better distribution of anchorage and more reasonable distribution of orthodontic force and tracting force can be achieved by properly using the two additional forces, in order to obtain better treatment results.

According to another embodiment, several openings can also be formed on the sidewall of the dental appliance, which can adjust the distribution of orthodontic forces. The shape, position and size of the openings can be designed based on the requirement for the distribution of the orthodontic forces. In general, most openings are positioned at the region of sidewall of dental appliance, where the elastic deformation is relatively small during use, or the region where small or no orthodontic force is generated during use as desired by the treatment, or the occlusal surface of the dental appliance. The size and shape of the openings can be designed based on the size and shape of the corresponding regions.

The aforementioned orthodontic side stem, tracting hook and opening can adjust the distribution of orthodontic forces. The mounting and modification of orthodontic side stem or tracting hook, or the modification and finishing on the openings can be made after the blank appliance is pressed using membranes based on the male mold.

According to another embodiment, at step S103, for example, two identical dental appliances can be manufactured using the membrane of the same material with the same thickness, followed by an attachment design sub-step, such as, forming some openings on one of the dental appliances to reduce the orthodontic force. Because the orthodontic force provided by the dental appliance with openings is smaller, it is more comfortable to wear for the patient, and the smaller stress generated leads to a lower rate and smaller amount of teeth movement, which is more suitable for the patient to use first during the treatment. The dental appliance without openings provides a larger orthodontic force, leading to a higher rate and greater amount of teeth movement, which is more suitable for the patient to use later, to increase the orthodontic force in the later treatment.

Moreover, as an example, two identical dental appliances can be pressed using membranes of the same material with the same thickness, and tracting hook can be attached on one of two dental appliances to generate a lateral orthodontic force. Next, based on actual needs, the patient can wear the dental appliance without tracting hooks for 6-7 days, and then wear the dental appliance with tracting hooks for another 6-7 days, in order to optimize the treatment result.

Moreover, different attachments (including not only all the attachments listed here, but also other types of attachment that might be used in the future) can be used in any combination based on actual situations. After two identical dental appliances are pressed using membranes of the same material with the same thickness based on one male mold, attachments can be attached to make two dental appliances providing different orthodontic forces. The order in which to use those appliances can be adjusted properly during use to optimize the treatment results.

Besides, having/attaching different attachments used in the present invention includes the case that each of the two or more dental appliances in one set is attached with attachments, but these attachments may be of different kinds, sizes or shapes, and also the case that only several of the two or more dental appliances are attached with attachments while the rest are without attachments. Both of these cases fall within the scope of the present invention.

Note that, in actual practice, any of the A, B, C and D methods mentioned above can be used individually, or multiple of the methods can be combined to achieve the best effect. For example, two or more dental appliances of different materials with different thicknesses can be manufactured, or two or more dental appliances with different thicknesses and different attachment designs can be manufactured based on one tooth model, etc. All the possible combinations fall within the scope of the present invention.

In summary, based on the embodiments mentioned above, for one treatment step, the method for manufacturing dental appliances includes manufacturing a set of appliances instead of pressing one invisible appliance based on one physical tooth model. The set of dental appliances include at least two (preferably 2-4) dental appliances, to reduce the number of digital model designs corresponding to physical tooth models, and to reduce the processing work for physical tooth models. The two different dental appliances are manufactured based on one male mold, using the membranes of different materials and/or with different thicknesses, or different means of processing the membranes and appliances, or different attachments attached to dental appliances. The use order shall be arranged properly in order to optimize the treatment result and use comfort level, to save the materials and time cost required for making male molds, and to shorten the treatment cycles.

Manufacturing Methods Requiring No Male Mold

FIG. 2 illustrates an exemplary process for manufacturing dental appliances. A person skilled in the art can make any modifications, such as, generating data of a female mold (negative model), and manufacturing the invisible dental appliances with corresponding shapes based on the female mold data by rapid prototyping technology.

FIG. 3 illustrates an exemplary process for manufacturing dental appliances by “direct manufacturing process”, according to one embodiment of the present invention.

As described in the background, all the existing methods for manufacturing dental appliances require making tooth models first, and then manufacturing dental appliances by hot press molding. However, such methods require a physical tooth model to be made first, which is time-consuming. Besides, additional materials are consumed by making the physical tooth models, and it is adverse to manufacturing of dental appliances in special auxiliary shapes or with attachments.

Accordingly, in the present invention, a “direct manufacturing process” is provided, which includes manufacturing two or more dental appliances for each treatment step. As illustrated in FIG. 3, firstly, at step S201, a dental digital model representing an orthodontic status is acquired. How to acquire the dental digital model representing the orthodontic status can be referred to step S101 mentioned above, which will not be repeated herein.

Next, at step S202, a digital model of dental appliance representing the shape of dental appliance is generated based on the dental digital model mentioned above. Because the geometric shape of the dental appliance is designed to have cavities for receiving teeth, which are generally compatible with one or more teeth on the jaw that the dental appliance corresponds to, and each cavity can receive or substantially copy a reverse shape of a tooth.

Therefore, based on the male mold of the teeth orthodontic status acquired at step S201, the digital model of the inside of the dental appliance substantially fitting with a profile of the orthodontic status (female mold) can be acquired using a conventional computer data processing method, such as computer-aided design (CAD), by shifting from the surface of each tooth crown by a distance of 0.05 mm or more.

In particular, the basic digital data of a geometric shape of the cavity inside the surface of dental appliance is acquired based on the digital model of the orthodontic status. Furthermore, the thickness of the dental appliance is determined. For example, the thickness of dental appliance may be 0.5-1 mm, which however can vary based on different materials and treatment requirements.

Next, at step S203, the digital model of dental appliance can be transformed into dental appliances by rapid prototyping technology.

The layered digital model of dental appliance can be processed by rapid prototyping technology, such as Stereo lithography Apparatus (SLA), Laminated Object Manufacturing (LOM), Laser Sintering (SLS), Fused Deposition Modeling (FDM), Three Dimensional Printing (3DP) etc., in order to manufacture physical dental appliances. For examples, according to one embodiment, the physical dental appliances can be manufactured by the three dimensional printing method.

Moreover, based on the following embodiments of A′ to E′, the details of performing aforementioned steps S201-203 are elaborated in detail below.

A′. According to one embodiment of the present invention, at the step S202, two or more digital models of dental appliance are generated based on one dental digital model, in order to manufacture two or more two dental appliances with different thicknesses at step S203. The two or more digital models of dental appliance can also be generated by a slight adjustment on the basic digital model of dental appliance fitting with the profile of the orthodontic status.

For example, a first digital model of a first dental appliance is relatively thinner, and a second digital model of a second dental appliance is relatively thicker, resulting in the first physical dental appliance manufactured thinner and the second physical dental appliance manufactured thicker. During use, a patient wears the thinner second dental appliance for about a week (6-7 days), and then switches to the thicker first dental appliance for about a week, to complete one treatment step.

B′. According to another embodiment of the present invention, at step S202, only one digital model for the dental appliance is generated for each treatment step. However, at step S203, two or more dental appliances are manufactured using materials with different elastic modulus. For different teeth and/or different portions of a tooth, the choice on materials with different elastic modulus can be made to introduce different resilience forces to the different teeth and/or different portions of the tooth, which is caused by elastic deformation of the dental appliances, so that the orthodontic forces applied to the different teeth and/or different portions of the tooth can be controlled and the rate and the amount of teeth movement can be controlled.

For example, a first dental appliance can be manufactured using a first material with a larger elastic modulus and a second dental appliance can be manufactured using a second material with a smaller elastic modulus. During use, a patient may wear the second dental appliance with the smaller elastic modulus for about a week, and then switches to the first dental appliance with the larger elastic modulus for about a week, to complete the treatment of one treatment step.

C′. According to another embodiment of the present invention, post-processing sub-steps are added to the step S203. For two or more manufactured dental appliances, different post-processing methods allow the two or more manufactured dental appliances to provide different orthodontic forces. The particular post-processing methods can be referred to section C mentioned above, which will not be repeated herein.

D′ According to another embodiment of the present invention, attachment design sub-steps are added to step S202. Two or more digital models of dental appliance with attachments can be generated based on one dental digital model, so that the two or more dental appliances with different attachments can be manufactured at step S203.

In particular, at step S202, for one treatment step, a basic digital model for dental appliance is generated based on one dental digital model. In addition to the basic digital model for dental appliance, a digital model for attachments is added in order to design the two or more digital models for dental appliance with different attachments, so that the two or more dental appliances with different attachments can be manufactured at step S203.

E′. According to another embodiment of the present invention, attachment design sub-steps are added to step S203. After two or more dental appliances are manufactured based on the digital model for dental appliance, additional processing and modification can be made to the attachments to allow different attachments attached to the two or more dental appliances.

In summary, based on the direct manufacturing process, for each treatment step, as long as one dental digital model is determined, two different dental appliances with different orthodontic forces can be manufactured without using a male mold, which accelerates the designing of treatment plan, improves the treatment effect and use comfort, and shortens the treatment cycle, by using the dental appliances in an appropriate order.

### Dental Appliances and Use Method Thereof

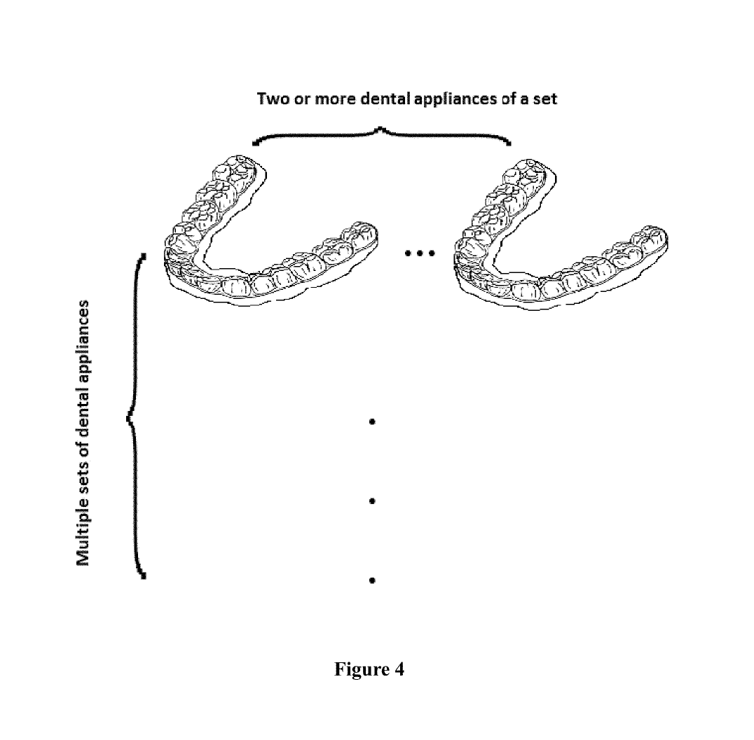

The successive multiple sets of dental appliances shown in FIG. 4 are manufactured according to the method mentioned above. The dental appliances have cavities of respective predetermined shapes in order to move the teeth from an initial tooth arrangement to a desired tooth arrangement gradually, wherein each set of dental appliances corresponds to one treatment step designed using a computer. A patient wears each set of dental appliances successively based on a fractional treatment plan, to move the teeth from the initial tooth arrangement to the desired tooth arrangement, to achieve the orthodontic purpose.

Besides, based on the present invention, each set of dental appliances of the multiple sets of dental appliances may have two or more dental appliances of substantially the same geometric shape. When the patient wears each dental appliance of the two or more dental appliances, the each dental appliance applies a different force to the teeth.

The patient wears a first dental appliance with a smaller orthodontic force for a first suggested period of time, and after the first suggested period of time, the first dental appliance with the smaller orthodontic force is replaced by a second dental appliance with a larger orthodontic force, which will be put on the teeth for a second suggested period of time.

For example, according to an embodiment, one or several treatment steps are associated with a set of two dental appliances. A first invisible dental appliance in the set is used continuously for 6-7 days, and then another invisible dental appliance having substantially the same geometric shape is used continuously for another 6-7 days. Another set of dental appliance is used afterwards, until the last set of dental appliances is used.

According to another embodiment, one or several treatment steps are associated with a set of three dental appliances. A first invisible dental appliance in the set is used continuously for 4 days, and then a second invisible dental appliance of substantially the same geometric shape is used continuously for another 4 days, and then a third invisible dental appliance of substantially the same shape is used continuously for another 4 days. Another set of dental appliances will be used afterwards, until the last set of dental appliances is used.

According to another embodiment, one or several treatment steps are associated with a set of four dental appliances. A first invisible dental appliance in the set is used continuously for 3 days, and then a second invisible dental appliance of substantially the same geometric shape is used continuously for another 3 days, and then a third invisible dental appliance of substantially the same shape is used continuously for another 3 days, and then a fourth invisible dental appliance of substantially the same shape is used continuously for another 3 days. Another set of dental appliance will be used afterwards, until the last set of dental appliances is used.

Note that, as for the multiple sets of dental appliances required for a treatment process, in some cases, each set of dental appliances may include two or more dental appliances of substantially the same shape, and in some other cases, at least one set may include two or more dental appliances of substantially the same geometric shape while each set of the rest sets may only includes one dental appliance.

In summary, compared with the current technology, using two, three or four invisible dental appliances manufactured using the manufacturing method mentioned for one treatment step can reduce the use time of an invisible dental appliance from 14 days to 3-7 days, which ensures enough elastic stress of the invisible dental appliances during the use and significantly shortens a treatment cycle, but still achieves desired treatment results. Therefore, the invisible dental appliances can be promoted among malocclusion patients. Moreover, manufacturing two dental appliances with different orthodontic forces based on one dental digital model not only saves the materials and time, but also improves the treatment effects and comfort level for use.

While various embodiments of the disclosed method and apparatus have been described above, other aspects and embodiments are obvious to a person skilled in the art. The aspects and embodiments have been presented by way of example only, and not of limitation. The scope and spirit of the present disclosure is defined by the amended claims.

Similarly, various diagrams may depict an exemplary architecture or other configuration for the disclosed method and apparatus, which may help to understand the features and functionality that can be included in the disclosed method and apparatus. The claimed invention is not limited to the illustrated exemplary architectures or configurations, and the desired features can be implemented using a variety of alternative architectures and configurations. Moreover, with regard to the flow charts, operational descriptions and method claims, the order in which the blocks are presented herein shall not mandate that various embodiments be implemented to perform the recited functionality in the same order unless the context dictates otherwise.

Unless otherwise specified herein, terms, phrases and variations thereof shall be construed as open-ended rather than limiting. In certain examples, using terms, phrases or the like such as “one or more”, “at least”, “but not limited to”, etc. shall not be construed as an intention or requirement to narrow the scope of examples without such terms or phrases.

What is claimed is:

1. A complex orthodontic system, comprising:
multiple sets of dental appliances, wherein the multiple sets of dental appliances comprise cavities of respective predetermined geometric shapes to move teeth of a patient from an initial tooth arrangement to an expected tooth arrangement gradually;
wherein at least one set of the multiple sets of dental appliances comprises two or more dental appliances of substantially the same geometric shape.

2. The system of claim 1, wherein orthodontic forces applied to the teeth of the patient by the two or more dental appliances are different when these dental appliances are put on the teeth of the patient, respectively.

3. The system of claim 2, wherein a first dental appliance with a smaller orthodontic force is put on the teeth of the patient for a first suggested period of time, and after the first suggested period of time, the dental appliance with the smaller orthodontic force is replaced by a second dental appliance with a larger orthodontic force, which is put on the teeth of the patient for a second suggested period of time.

4. The system of claim 1, wherein the two or more dental appliances have different thicknesses.

5. The system of claim 4, wherein a first dental appliance with a thinner thickness is put on the teeth of the patient for a first suggested period of time, and after the first suggested period of time, the first dental appliance is replaced by a second dental appliance with a thicker thickness, which is put on the teeth of the patient for a second suggested period of time.

6. The system of claim 1, wherein the two or more dental appliances are made of materials having different elastic modulus.

7. The system of claim 6, wherein a first dental appliance made of a first material with a smaller elastic modulus is put on the teeth of the patient for a first suggested period of time, and after the first suggested period of time, the first dental appliance made of the first material with the smaller elastic modulus is replaced by a second dental appliance made of a second material with a larger elastic modulus, which is put on the teeth of the patient for a second suggested period of time.

8. The system of claim 1, wherein the two or more dental appliances are post-processed differently, so that orthodontic forces applied to the teeth of the patient by the two or more dental appliances are different, when the two or more dental appliances are put on the teeth of the patient, respectively.

9. The system of claim 1, wherein the two or more dental appliances have different attachments, so that orthodontic forces applied to the teeth of the patient by the two or more dental appliances are different, when the two or more dental appliances are put on the teeth of the patient, respectively.

10. A method for manufacturing complex dental appliances, comprising:
a) acquiring a dental digital model representing an orthodontic status;
b) making a male mold for dental appliance based on the dental digital model; and
c) manufacturing two or more dental appliances based on the male mold for dental appliance,
wherein the two or more dental appliances are of substantially the same geometric shape.

11. The method of claim 10, wherein the male mold for dental appliance is made by rapid prototyping technology at step b).

12. The method of claim 10, wherein step c) comprises pressing one or more membranes of the dental appliances using the male mold for dental appliance to obtain the two or more dental appliances.

13. The method of claim 10, wherein orthodontic forces applied to teeth of a patient by the two or more dental appliances are different when these dental appliances are put on the teeth of the patient, respectively.

14. The method of claim 13, wherein step c) comprises manufacturing a first dental appliance with a larger orthodontic force and manufacturing a second dental appliance with a smaller orthodontic force based on a same male mold for dental appliance.

15. The method of claim 10, wherein the two or more dental appliances have different thicknesses, and step c) comprises manufacturing a first dental appliance with a thicker thickness and manufacturing a second dental appliance with a thinner thickness based on a same male mold for dental appliance.

16. The method of claim 10, wherein the two or more dental appliances are made of materials with different elastic modulus, and step c) comprises making a first dental appliance with a first material with a larger elastic modulus and making a second dental appliance with a second material with a smaller elastic modulus based on a same male mold for dental appliance.

17. The method of claim 10, further comprising: d) subsequent to step c), post-processing the two or more dental appliances differently.

18. The method of claim 10, wherein step c) further comprises attaching different attachments to the two or more dental appliances.

19. A method for manufacturing complex dental appliances, comprising:
a) acquiring a dental digital model representing an orthodontic status;
b) generating a digital model for dental appliance based on the dental digital model; and
c) manufacturing two or more dental appliances of substantially the same geometric shape based on the same digital model for dental appliance.

20. The method of claim 19, wherein the dental appliance is made by rapid prototyping technology at step c).

21. The method of claim 19, wherein orthodontic forces applied to teeth of a patient by the two or more dental appliances are different when these dental appliances are put on the teeth of the patient, respectively.

22. The method of claim 19, wherein step b) comprises generating two or more digital models for dental appliance with different thicknesses based on the same dental digital model, and step c) comprises manufacturing the two or more dental appliances with different thicknesses using the two or more digital models for dental appliance.

23. The method of claim 19, wherein step c) comprises manufacturing two or more dental appliances based on the same digital model for dental appliance using materials with different elastic modulus.

24. The method of claim 19, further comprising post-processing the two or more dental appliances differently subsequent to step c).

25. The method of claim 19, wherein step b) further comprises attaching different attachments to the same digital model for dental appliance; and step c) further comprises manufacturing the two or more dental appliances based on the digital model for dental appliance with the different attachments.

26. The method of claim 19, wherein step c) further comprises attaching different attachments to the two or more dental appliances.

27. A method for using a complex orthodontic system, comprising:
applying a first dental appliance of a set of dental appliances to teeth of a patient for a first suggested period of time, wherein the set of dental appliances comprise two or more dental appliances having substantially the same geometric shape; and
replacing the first dental appliance with a second dental appliance of the set of dental appliances for a second suggested period of time after the first suggested period of time.

28. The method of claim 27, wherein an orthodontic force of the first dental appliance is smaller than an orthodontic force of the second dental appliance.

29. The method of claim 28, wherein a wall of the first dental appliance is thinner than a wall of the second dental appliance.

30. The method of claim 27, wherein the first suggested period of time and the second suggested period of time are 4-7 days.
